(19) United States
(12) Patent Application Publication
(10) Pub. No.: US 2004/0037575 A1
(43) Pub. Date: Feb. 26, 2004

(54) Image forming apparatus

(75) Inventor: Kazufumi Ishida, Mishima (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/227,288

(22) Filed: Aug. 26, 2002

(51) Int. Cl. G03G 15/08

(52) U.S. Cl. 399/27; 399/258; 399/260

(57) ABSTRACT

An image forming apparatus is provided which is able to be constructed in compact size without using mechanical dedicated parts such as a shutter and the like while being capable of properly controlling an amount of developer to be supplied through dropping. As the image forming apparatus of the present invention is constructed as explained above, electromagnet couples A, B, -, G of an electromagnet unit 10 of a magnetic field generator generate magnetic fields, which are arranged in multiple stages in horizontal directions along a conventional developer drop duct DT, thereby creating a magnetic field pattern and moving it in a downward direction at an appropriate speed. As a result, an amount of drop of the developer TN falling or dropping through the duct can be controlled to be an appropriate amount. That is, the developer naturally falling under gravity through the duct is controlled by the moving speed of the magnetic field pattern so that the developer can be supplied to a developing device by an appropriate amount of drop. In this case, no mechanical dedicated parts such as a shutter and the like are used, and hence the apparatus can be constructed in compact size by utilizing an existing space along the duct.

### BACKGROUND OF THE INVENTION

1. Field of the Invention

The present invention relates to an image forming apparatus, and more particularly, to such an image forming apparatus in which a developer supplied from a hopper or the like is conveyed by a developer supply device, and dropped on a developing device through a developer drop path, so that the developing device receiving the dropped developer supplies it to a photoreceptor by a constant amount each time thereby to perform image formation.

2. Description of the Related Art

Conventional dry developing methods are roughly divided into a one-component developing method using a toner alone as a developer and a two-component developing method using a toner and a carrier. There is also a further method that is in particular called a pseudo two-component developing method in which a small amount of magnetic carrier is adhered to the circumference of a developing roller and carried thereby to perform development In the one-component developing method, when a magnetic component is contained in the toner, the toner is basically attracted to a magnet roller and carried onto a photoreceptor by the use of the rotational force of the developing roller. In the two-component developing method, the toner is mixed with the carrier at a prescribed ratio, and the toner is electrified by friction between the toner and the carrier. A magnetic brush is formed on the magnet roller so that the toner is moved onto the photoreceptor to form an image thereon. A permanent magnet is generally used for the construction of the magnet roller. The magnetic force and the number of revolutions per unit time of the magnet roller are constant in principle. A doctor blade is used for restricting the thickness of a layer of the magnetic brush. In either of the cases mentioned above, an amount of toner equal to that supplied to the photoreceptor is replenished to the developing roller. However, the toner is generally received in a separate cartridge and it is supplied therefrom to the main body of the developing device through a replenishment path as necessary.

In the conventional image forming apparatus as mentioned above, the toner for replenishment, which is often provided in the form of a cartridge handled as a consumable supply in addition to the developing device main body, is sent out to the developing roller through the prescribed replenishment path to form an image on the photoreceptor. The simplest transportation means in the course of transportation of this toner is the one using the principle of free fall. This transportation means is a system in which the toner falls or drops in a space of a constant width, and hence the transportation of the toner can be carried out without acting against gravity. As a result, this transportation means is of a feasible construction. However, when the toner starts to fall or drop, it is basically impossible to control the amount of fall or drop of the toner, so the amount of transportation (amount of drop) of the toner is based on the natural law Therefore, some thought of controlling the amount of transportation (amount of drop) of the toner in a stage before the fall or drop starts is needed. Concretely, a predetermined amount of toner is controlled to fall or drop by using a shutter or a roller. In this case, in order to transport and drop the predetermined amount of toner in a reliable manner, it is necessary to incorporate some dedicated parts in the transportation means. As a consequence, the cost of manufacture is increased, and a space for incorporation of the dedicated parts is needed. These might become impediments to the miniaturization of the entire apparatus.

Moreover, when the property of the toner is changed under the influence of environmental changes, there might be caused the disorderly transportation of the toner which would shift the amount of drop from an estimated value. Being unable to supply the same amount of toner as that supplied to the photoreceptor to the developing roller finally results in degradation of image quality. Therefore, if possible, it is preferable that the amount of transportation be always controlled while the toner is dropping. Though the apparatus becomes somewhat complicated in construction, it is practiced that a specified amount of toner is transported directly to a developing part by the use of augers or the like. In any case, the dedicated parts and the installation space are needed to transport a constant amount of toner in a reliable manner, thus posing not a little problem. In addition, there is also another problem in that when the distance of fall or drop of the toner to the developing device is large (for instance, in cases where it is impossible to arrange a toner supply port at a lower position near the developing device because of the structure of the image forming apparatus), the potential energy generated upon falling or dropping of the toner is so large that the toner might be dispersed or the particle shapes of the toner might be damaged at its dropped position, thus giving rise to adverse influences on the quality of an image to be formed.

### SUMMARY OF THE INVENTION

The present invention is intended to solve the problems as referred to above, and has for its object to provide an image forming apparatus which is able to be constructed in compact size by utilizing an existing space while being capable of properly controlling the amount of a developer (toner) to be supplied through dropping as well as reducing the dispersion of the toner upon falling thereof without using mechanical dedicated parts such as a shutter, a roller or the like.

In order to solve the above-mentioned problems, the present invention resides in an image forming apparatus including: a developer supply device for conveying a developer supplied thereto to permit it to drop through a developer drop path; a developing device for receiving, agitating and conveying the developer dropped from the developer supply device; a photoreceptor for receiving the developer conveyed by the developing device to perform image formation; and a magnetic field generator for generating a plurality of magnetic fields that are oriented in horizontal directions at positions of different heights along the the developer drop path, and moving a magnetic field pattern formed of the plurality of thus generated magnetic fields in a downward direction at a set speed thereby to adjust an amount of drop of the developer dropping through the developer drop path.

According to such a arrangement, the magnetic field generator generates magnetic fields in multiple stages acting in horizontal directions along the conventional developer drop path to form a magnetic field pattern. Thus, by moving the magnetic field pattern downwardly at an appropriate speed, the amount of the developer falling or dropping through the developer drop path can be controlled to an appropriate amount That is, the developer falling or dropping naturally under the action of gravity in the developer drop path is controlled by the moving speed of the magnetic field pattern so that the developer is supplied to the developing device at the appropriate amount of drop thereof. As a result, the dispersion of the developer at its dropped position can be reduced.

Moreover, in the present invention, the developer drop path comprises a duct having opposed walls between which the developer is able to drop. The magnetic field generator comprises: a plurality of electromagnet couples arranged in multiple stages vertically at a constant pitch along the opposed walls of said duct; and a control circuit for selecting some of the plurality of electromagnet couples by properly switching between them at a set speed, generating the magnetic field pattern and moving it in a downward direction at a set speed by supplying an electric current to the some electromagnet couples thus switchingly selected. In this case, the electromagnets of each electromagnet couple comprising two electromagnets are arranged in an opposed relation with each other with the duct interposed therebetween so that when electric current is supplied to them, magnetic fields acting in horizontal directions can be easily generated. Moving the magnetic field pattern generated by the plurality of electromagnet couples can be easily carried out by switching between the electromagnet couples to be supplied with electric current at an appropriate speed to select any of them.

In addition, in the present invention, the control circuit receives from the developing device information about the excess and deficiency of the amount of the developer held by the developing device, and controls the speed at which the magnetic field pattern is moved in such a manner that the amount of the developer held by the developing device comes to be an appropriate amount. As a result, information about the excess and deficiency of the amount of the developer in the developing device is fed back to the control circuit whereby the amount of the developer held by the developing device is automatically adjusted to the appropriate amount.

### BRIEF DESCRIPTION OF THE DRAWINGS

FIG. 1 is a cross sectional view showing an image forming apparatus of the present invention.

FIG. 2 is a cross sectional view showing electromagnet couples of an electromagnet unit of a developer drop amount control device used in the image forming apparatus in FIG. 1.

FIG. 3 is a block diagram showing a control circuit that drives and controls the electromagnet couples of the electromagnet unit in FIG. 2, and that constitutes, together with the electromagnet unit, a magnetic field generator.

FIG. 4 is a circuit diagram illustrating in detail an excitation circuit shown in FIG. 3.

FIG. 5 is a timing chart illustrating drive pulse signals for generating respective excitation signals in FIG. 4.

FIG. 6(A) and FIG. 6(B) are views explaining examples in which the electromagnet couples are excited by the excitation signals in FIG. 4.

FIG. 7 is a view explaining magnetic field patterns which vary according to the output timings M1, M2, M3 and M4 of the drive pulse signals in FIG. 5.

### DESCRIPTION OF THE PREFERRED EMBODIMENT

Now, a preferred embodiment of the present invention will be described below in detail while referring to the accompanying drawings. Note that in this embodiment, a dry developing method is employed, and a toner with a magnetization characteristic, a developer for a pseudo two-component developing method comprising the toner and a carrier mixed with each other, a developer for a two-component developing method, etc., are used.

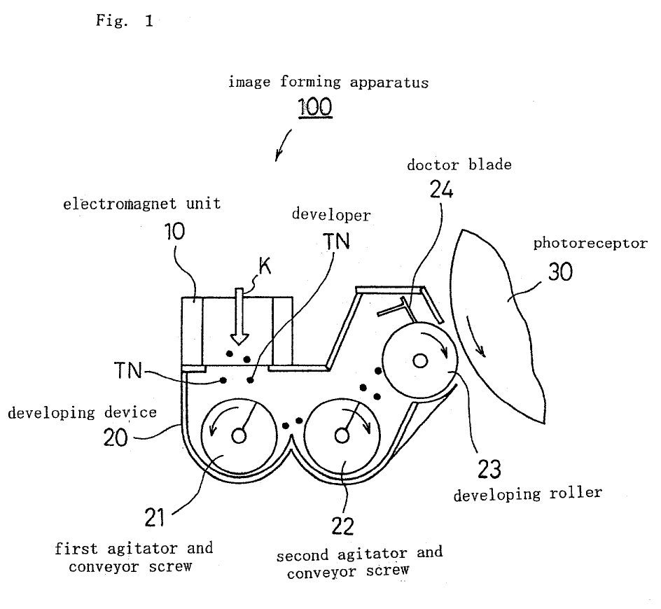

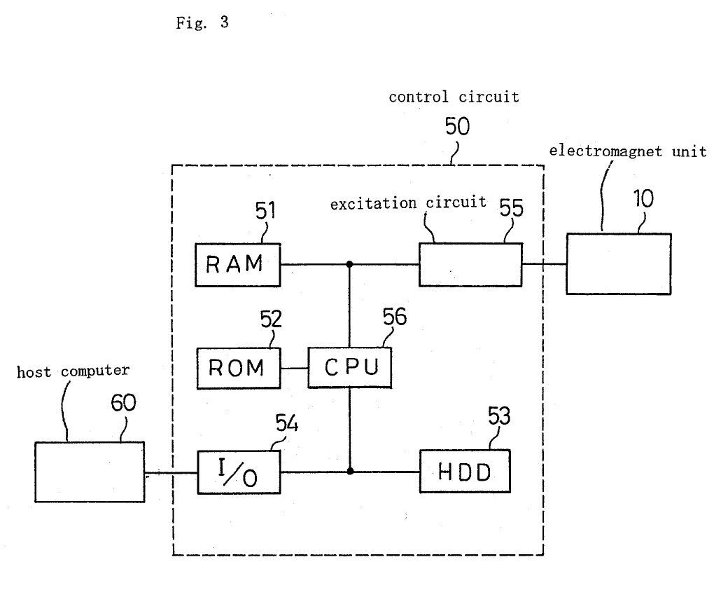

An image forming apparatus 100 shown in FIG. 1 includes an electromagnet unit 10, a developing device 20, a photoreceptor 30, and a control circuit 50 separately shown in FIG. 3. The electromagnet unit 10 receives the developer, which is supplied from and dropped by a developer supply device (not shown) as indicated at an arrow K, and supplies the thus received developer to the developing device 20 while controlling the falling or dropping speed or amount thereof by applying a magnetic force thereto. The developing device 20 includes a first agitator and conveyor screw 21 for receiving, agitating and conveying the developer falling or dropping from the electromagnet unit 10, a second agitator and conveyor screw 22 for further agitating and conveying the developer that has been conveyed from the first agitator and conveyor screw 21, a developing roller 23 for supplying the developer that has been conveyed from the second agitator and conveyor screw 22 to the photoreceptor 30, and a doctor blade 24 for restricting the thickness of a layer of a magnetic brush, which is formed on the surface of the developing roller 23 upon the developer being supplied thereto, to supply an appropriate amount of the developer to the photoreceptor 30. The photoreceptor 30 forms an image on a recording medium by using the developer thus supplied.

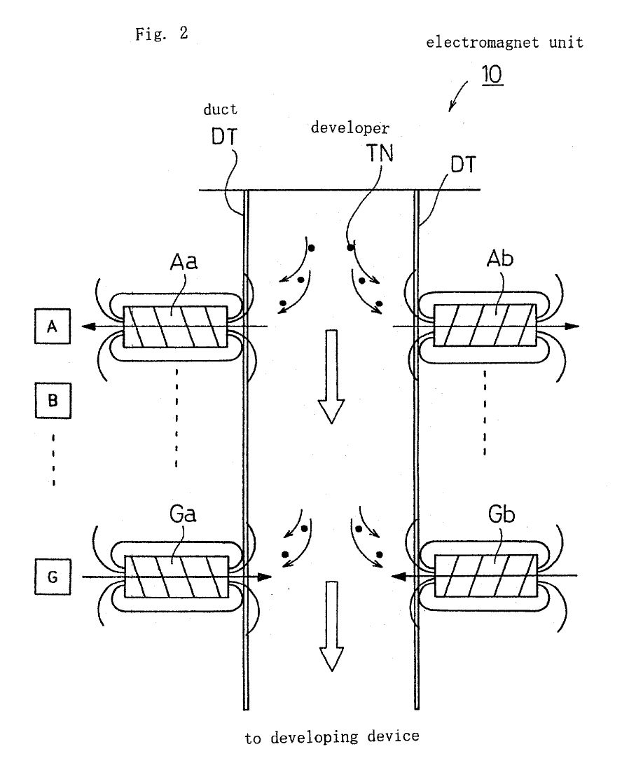

The electromagnet unit 10 of FIG. 1 includes, as shown in FIG. 2, a duct DT that forms a drop path for the developer, electromagnet couples A, B, -, G that are arranged on the opposed walls of the duct DT at equal intervals with the duct DT interposed therebetween, and an electromagnet control circuit as shown in FIG. 3. Each of the electromagnet couples A, B, -, G is constituted by two electromagnets respectively arranged on the opposed walls of the duct DT (For instance, an electromagnet couple A is constituted by electromagnets Aa and Ab.) In this example, the two electromagnets in each of the electromagnet couples A, B, -, G are connected with each other in such a manner that they generate magnetic fields acting in the opposite directions (horizontal arrows) with respect to the duct DT Here, note that the electromagnets are not limited to the electromagnet couples as shown in FIG. 2, but electromagnets of other configurations can be used if they can generate magnetic fields in multistages acting in horizontal directions.

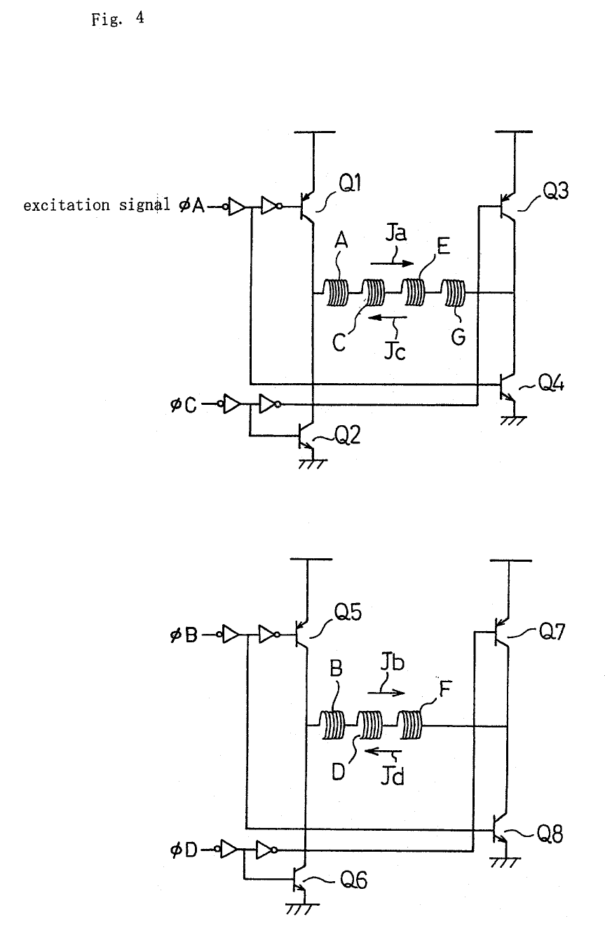

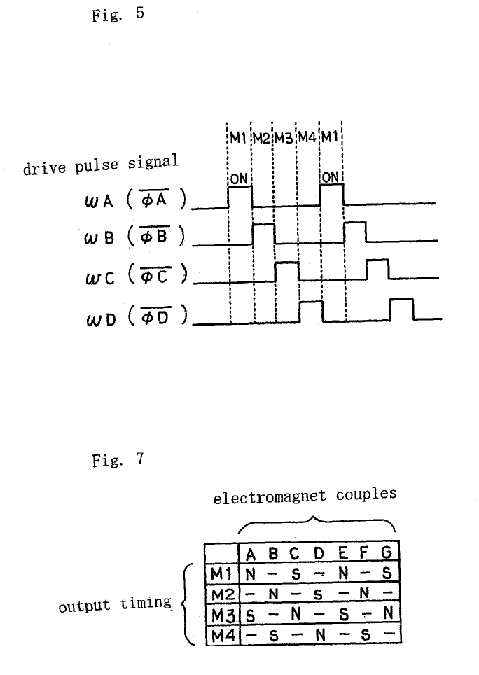

The control circuit 50 shown in FIG. 3 is provided with a RAM 51, a ROM 52, a HDD 53, an I/O interface 54, an excitation circuit 55, and a CPU 56. The CPU 56 receives an instruction from a higher level host computer 60 through the I/O interface 54, and drives the excitation circuit 55 according to control programs or the like stored in the ROM 52, thereby operating the electromagnet couples A, B, -, G of the electromagnetic unit 10. Accordingly, the control circuit 50 cooperates with the electromagnet unit 10 to constitute a magnetic field generator. The principal parts of the excitation circuit 55 of FIG. 3 are constructed as shown in FIG. 4, and excitation signals φA, φB, φC and φD used therein are generated by inverting the logic of drive pulse signals ωA, ωB, ωC and ωD (FIG. 5) supplied thereto from the CPU 56.

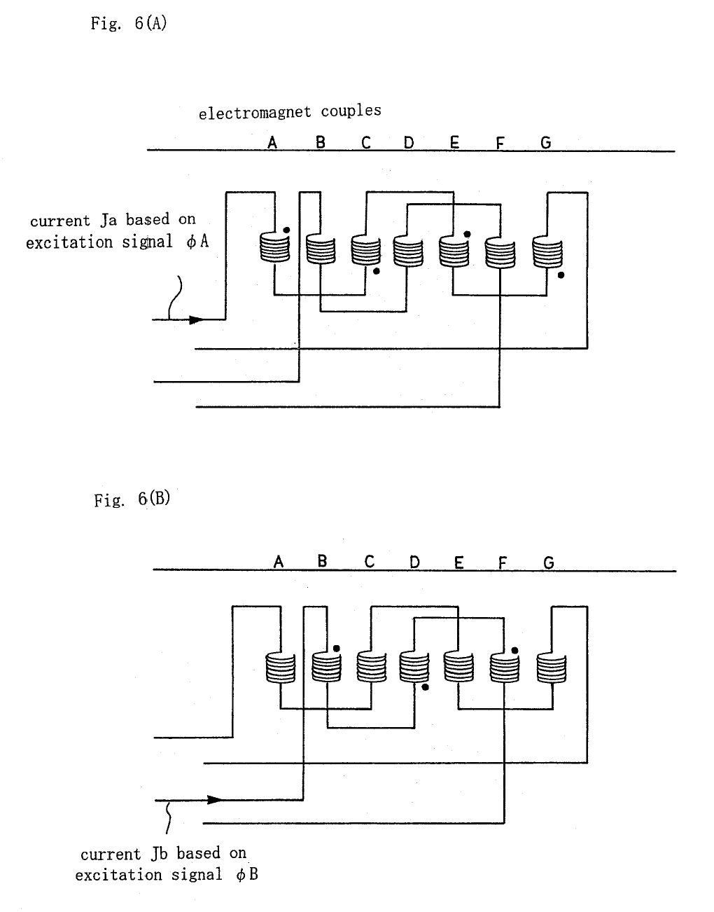

In the above case, for example, if the excitation signal φA is active (low level; at timing M1), transistors Q1 and Q4 are turned on. At this time, the excitation signals φB, φC and φD are inactive (high level), and hence transistors Q2, Q3, Q5, Q6, Q7 and Q8 are turned off. Accordingly, an electric current Ja flows through the electromagnet couples A, C, E and G, as shown in FIG. 4 and FIG. 6(A), and magnetic forces are generated with their N poles oriented in the directions as indicated at black spots in FIG. 6(A), whereas there is no flow of electric current through the electromagnet couples B, D and F On the other hand, if the excitation signal φB is active (low level; at timing M2), the transistors Q5 and Q8 are turned on and the excitation signals φA, φC and φD are inactive (high level), whereby the transistors Q1, Q2, Q3, Q4, Q6 and Q7 are turned off As a result, an electric current Jb flows through the electromagnet couples B, D and F to generate magnetic forces, as shown in FIG. 4 and FIG. 6(B), but on the other hand, there is no electric current flowing through the electromagnet couples A, C, E and G.

The electromagnet couples are also driven at timings M3, M4 as at timings M1, M2 mentioned above. That is, the transistors Q2 and Q3 are tuned on at timing M3, and the transistors Q6 and Q7 are turned on at timing M4. In this case, the state of the magnetic forces generated by the electromagnet couples A, B, -, G corresponding to the timings M1, M2, M3 and M4 based on the drive pulse signals ωA, ωB, ωC and ωD output from the CPU 56, if represented as a state diagram including the directions of “N” poles or “S” poles, is illustrated in FIG. 7. That is, it can be seen that a magnetic pattern generated at timing M1 is sequentially moved or shifted downward by the mounting pitch of the electromagnet couples A, B, -, G every time the following timing M2, M3 or M4 is successively reached, as shown at arrows in FIG. 2.

As can be understood from the above explanation, it is controlled such that the faster the speed of switching between the timings M1, M2, M3 and M4 based on the drive pulse signals ωA, ωB, ωC and ωD, the more becomes the amount of drop of the developer supplied to the developing device 20 through the electromagnet unit 10, whereas the slower the speed of switching between the timings M1, M2, M3 and M4, the smaller becomes the amount of drop of the developer to be supplied. In addition, these effects become large since such control is carried out just before the developing device. In this case, by obtaining information about the amount or concentration of the developer held by the developing device 20 from a detector that detects the amount or concentration of the developer held by the developing device 20, the movement of the magnetic field pattern according to the electromagnet unit 10 is automatically controlled at an optimal speed in such a manner that the amount of the developer held by the developing device 20 is made to be an appropriate amount or concentration. Further, by controlling the movement of the magnetic field pattern in the above manner, it is possible to brake the developer that would otherwise be falling or dropping freely or naturally irrespective of the speed of switching between the timings M1, M2, M3 and M4. As a result, the dispersion of the developer at the dropped position thereof is reduced, too. Although in the above-mentioned example, the plurality of electromagnet couples are driven by the same circuit, any of the electromagnet couples may be driven by an independent circuit. Additionally, all the electromagnet couples may be driven by independent circuits, respectively. Moreover, though the pulse widths of the drive pulse signals ωA, ωB, ωC and ωD have been assumed to be the same, they may vary one from another in accordance with the actual condition or the purpose thereof.

As the image forming apparatus according to the embodiment of the present invention is constructed as described above, magnetic fields, which are arranged in multiple stages in horizontal directions along the conventional developer drop path through which the developer falls or drops, are generated by means of the magnetic field generator, thus creating a magnetic field pattern. By moving the magnetic field pattern downwardly at an appropriate speed, the amount of drop of the developer falling or dropping through the developer drop path can be controlled to be an appropriate amount. That is, the developer falling or dropping naturally under the action of gravity through the developer drop path is controlled by the moving speed of the magnetic field pattern. As a result, the developer can be supplied to the developing device at the appropriate amount of drop, thereby making it possible to reduce the dispersion of the developer at the dropped position thereof. In this case, since mechanical dedicated parts such as a shutter, a roller and the like are not used, the entire apparatus can be constructed compactly by utilizing an existing space along the developer drop path.

What is claimed is:

1. An image forming apparatus comprising:
a developer supply device for conveying a developer supplied thereto to permit it to drop through a developer drop path;
a developing device for receiving, agitating and conveying the developer dropped from said developer supply device;
a photoreceptor for receiving the developer conveyed by said developing device to perform image formation; and
a magnetic field generator for generating a plurality of magnetic fields that are oriented in horizontal directions at positions of different heights along said the developer drop path, and moving a magnetic field pattern formed of the plurality of thus generated magnetic fields in a downward direction at a set speed thereby to adjust an amount of drop of the developer dropping through said developer drop path.

2. The image forming apparatus as set forth in claim 1, wherein said developer drop path comprises a duct for permitting the developer to drop between opposed walls thereof, and
said magnetic field generator comprises: a plurality of electromagnet couples arranged in multiple stages vertically at a constant pitch along said opposed walls, and a control circuit for properly switching between and selecting some of the plurality of electromagnet couples at a set speed, generating said magnetic field pattern and moving it in a downward direction at a set speed by supplying an electric current to said some electromagnet couples thus switchingly selected.

3. The image forming apparatus as set forth in claim 1, wherein said control circuit receives from said developing device information about the excess and deficiency of the amount of the developer held by said developing device, and controls the speed at which said magnetic field pattern is caused to move in such a manner that the amount of the developer held by said developing device becomes to be an appropriate amount.
